(19) United States
(12) Patent Application Publication
(10) Pub. No.: US 2022/0353870 A1
(43) Pub. Date: Nov. 3, 2022

(54) RELIABILITY ENHANCEMENT FOR SIDELINK COMMUNICATION

(71) Applicant: QUALCOMM Incorporated, San Diego, CA (US)

(72) Inventors: Sourjya DUTTA, San Diego, CA (US); Tien Viet NGUYEN, Bridgewater, NJ (US); Gabi SARKIS, San Diego, CA (US); Wanshi CHEN, San Diego, CA (US)

(21) Appl. No.: 17/653,276

(22) Filed: Mar. 2, 2022

Related U.S. Application Data
(60) Provisional application No. 63/182,705, filed on Apr. 30, 2021.

(51) Int. Cl. H04W 72/08

(52) U.S. Cl. CPC H04W 72/08; H04W 88/04

(57) ABSTRACT

Certain aspects of the present disclosure provide a method for wireless communications by a first user equipment, comprising receiving resource reservation information indicating a reservation of a future resource by at least a second user equipment, and forwarding the resource reservation information to one or more other user equipments when at least one condition is met.

### CROSS-REFERENCE TO RELATED APPLICATIONS

This application claims the benefit of and priority to U.S. Provisional Patent Application No. 63/182,705, filed on Apr. 30, 2021, the entire contents of which are incorporated herein by reference.

### BACKGROUND

### Field of the Disclosure

Aspects of the present disclosure relate to wireless communications, and more particularly, to enhancements for device-to-device sidelink communication based on selectively forwarded future resource reservation information.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

Sidelink communications are communications from one UE to another UE. As the demand for mobile broadband access continues to increase, there exists a need for further improvements in NR and LTE technology, including improvements to sidelink communications. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. After reading the section entitled “Detailed Description” one will understand how the features of this disclosure provide advantages that include improved device-to-device communications in a wireless network.

Certain aspects of this disclosure provide a method for wireless communications by a first user equipment (UE) for sidelink communication with other user equipments (UEs). The method generally includes receiving resource reservation information indicating a reservation of a future resource by at least a second UE; and forwarding the resource reservation information to one or more other UEs when at least one condition is met.

Certain aspects of this disclosure provide an apparatus for wireless communications by a first UE. The apparatus includes a memory and at least one processor coupled to the memory. The at least one processor is configured to obtain resource reservation information indicating a reservation of a future resource by at least a second UE; and forward the resource reservation information to one or more other UEs when at least one condition is met.

Certain aspects of this disclosure provide a first UE. The first UE includes means for receiving resource reservation information indicating a reservation of a future resource by at least a second UE; and means for forwarding the resource reservation information to one or more other UEs when at least one condition is met.

Certain aspects of this disclosure provide a non-transitory computer readable medium storing instructions that when executed by a user equipment (UE) as discussed herein cause the UE to: receive resource reservation information indicating a reservation of a future resource by at least a second UE; and forward the resource reservation information to one or more other UEs when at least one condition is met.

Certain aspects of this disclosure provide a method for wireless communications by a first user equipment (UE) for sidelink communication with other user equipments (UEs). The method generally includes receiving, from a second UE, resource reservation information indicating a reservation of a future resource by at least a third UE; and taking one or more actions based on the resource reservation information.

Certain aspects of this disclosure provide an apparatus for wireless communications by a first UE. The apparatus includes a memory and at least one processor coupled to the memory. The at least one processor is configured to obtain, from a second UE, resource reservation information indicating a reservation of a future resource by at least a third UE; and take one or more actions based on the resource reservation information.

Certain aspects of this disclosure provide a first UE. The first UE includes means for receiving, from a second UE, resource reservation information indicating a reservation of a future resource by at least a third UE; and means for taking one or more actions based on the resource reservation information.

Certain aspects of this disclosure provide a non-transitory computer readable medium storing instructions that when executed by a user equipment (UE) as discussed herein cause the UE to: receive, from a second UE, resource reservation information indicating a reservation of a future resource by at least a third UE; and take one or more actions based on the resource reservation information.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIGS. 5A and 5B show diagrammatic representations of example vehicle to everything (V2X) systems in accordance with some aspects of the present disclosure.

FIG. 6 illustrates an example allocation of a resource pool for sidelink communications, in accordance with certain aspects of the present disclosure.

FIG. 7 is an example resource pool for sidelink communication.

FIG. 8 illustrates two modes of sidelink communication.

FIG. 9 illustrates an example timeline of future resource allocations for sidelink communication, in accordance with certain aspects of the present disclosure.

FIG. 10 is a conceptual diagram illustrating how a node may interfere with transmissions between a transmitting UE and a receiving UE, in accordance with certain aspects of the present disclosure.

FIG. 11 is a table of example sets of resources for inter-UE coordination in mode 2 sidelink communication, in accordance with certain aspects of the present disclosure.

FIGS. 12A-12B illustrate deployments of various sidelink communications in which aspects of the present disclosure may be practiced.

FIG. 13 illustrates another deployment of sidelink communications in which aspects of the present disclosure may be practiced.

FIG. 14 illustrates example operations for wireless communications by a sidelink UE to forward future resource reservation information, in accordance with certain aspects of the present disclosure.

FIG. 15 illustrates example operations for wireless communications by a sidelink UE to process forwarded future resource reservation information, in accordance with certain aspects of the present disclosure.

FIGS. 16A-16C illustrate associated signaling and condition detection that may be implemented in an example sidelink deployment, in accordance with certain aspects of the present disclosure.

FIGS. 17 and 18 illustrate communications devices that may include various components configured to perform the operations illustrated in FIGS. 14 and 15, respectively, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to enhancements for device-to-device sidelink communication based on selectively forwarded future resource reservation information.

For example, a first sidelink receiving future resource reservation information (e.g., from a second UE for sidelink transmission to another UE) may only forward the resource reservation information if one or more conditions are met. By only forwarding the resource reservation information only when the one or more conditions are met, sidelink resources may be conserved and/or interference may be reduced.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

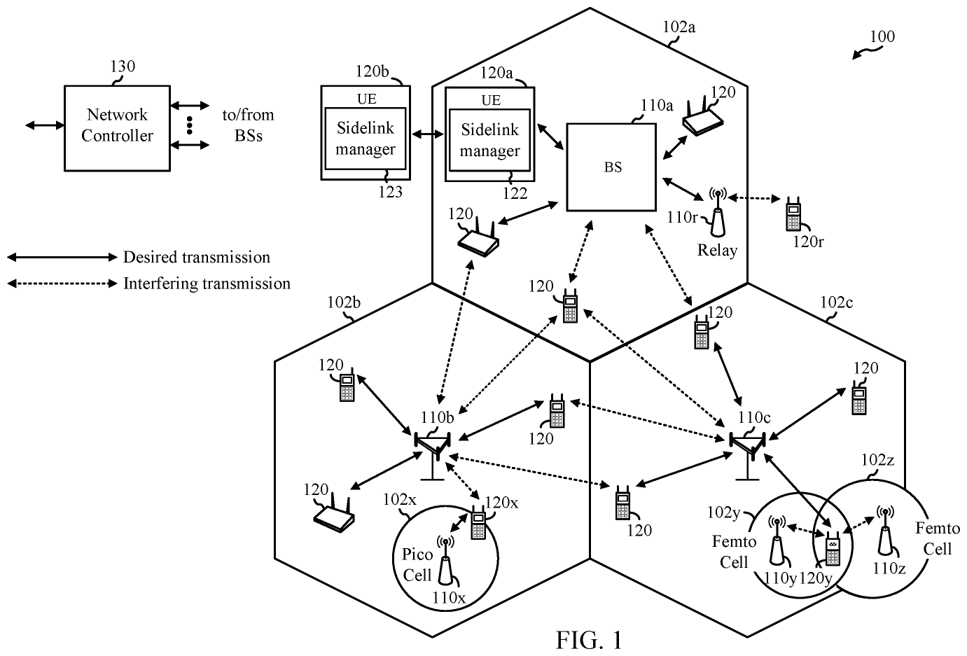

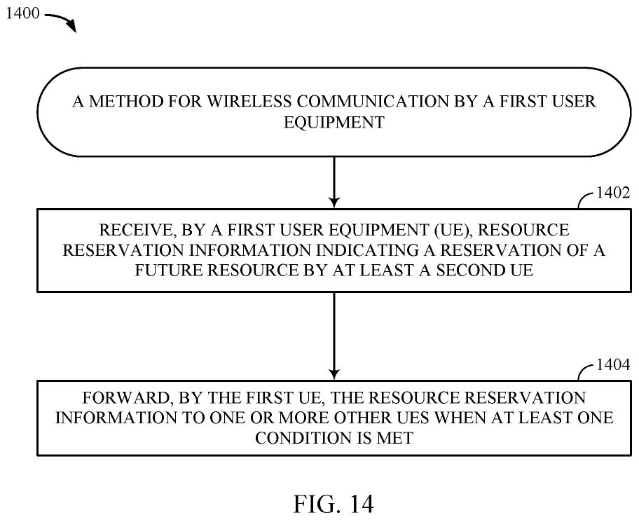

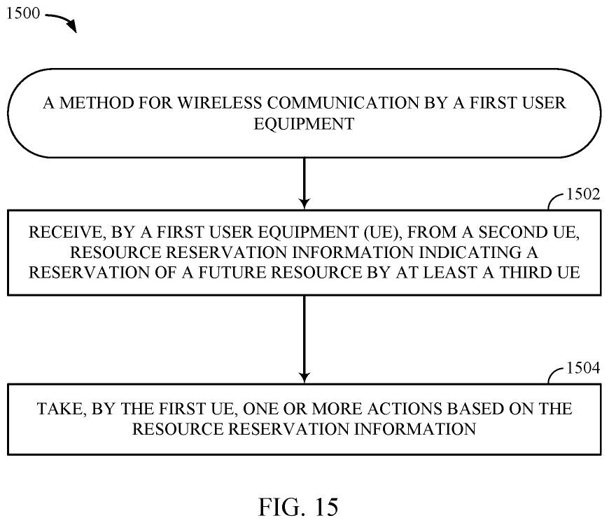

FIG. 1 illustrates an example wireless communication network 100 in which aspects of the present disclosure may be performed. For example, one or more UEs 120a and 120b of FIG. 1 may be configured to perform operations described below with reference to FIG. 14 to forward future resource reservation information to one or more other UEs when at least one condition is met and/or to perform operations 1500 of FIG. 15 to process such resource reservation information forwarded by another UE.

As illustrated in FIG. 1, the wireless communication network 100 may include a number of base stations (BSs) 110a-z (each also individually referred to herein as BS 110 or collectively as BSs 110) and other network entities. In aspects of the present disclosure, a roadside service unit (RSU) may be considered a type of BS, and a BS 110 may be referred to as an RSU. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network.

In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

According to certain aspects, the UEs 120 may be configured to determine resources to use for sidelink communications (with another UE). As shown in FIG. 1, the UE 120a includes a sidelink manager 122. The sidelink manager 122 may be configured to transmit/receive a sidelink communication to/from another UE, in accordance with aspects of the present disclosure. As shown in FIG. 1, the UE 120b includes a sidelink manager 123. The sidelink manager 123 may be configured to receive/transmit a sidelink communication from/to another UE, in accordance with aspects of the present disclosure.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node such as a UE or a BS may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using time division duplexing (TDD). Beamforming may be supported and beam direction may be dynamically configured. MIMO transmissions with precoding may also be supported. MIMO configurations in the DL may support up to 8 transmit antennas with multi-layer DL transmissions up to 8 streams, and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

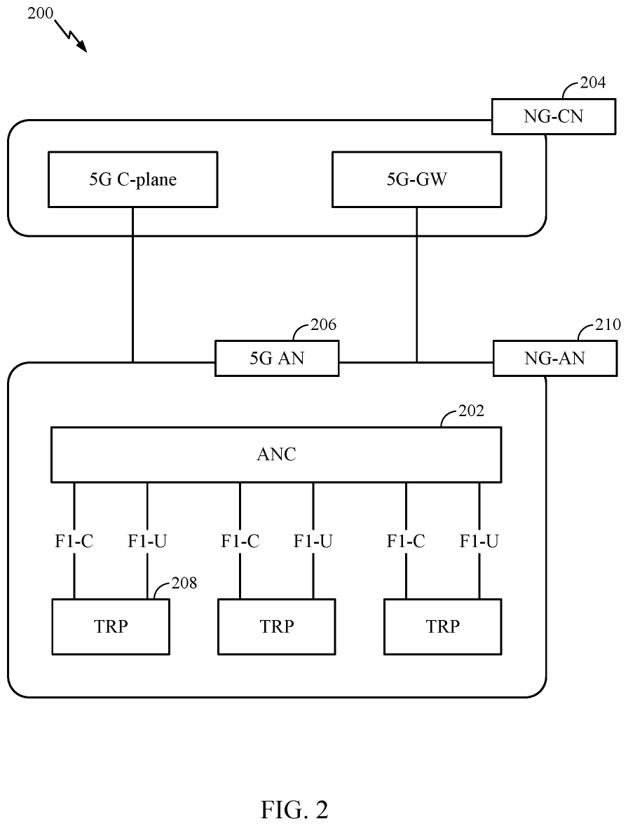

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

Logical functions may be dynamically distributed in the logical architecture of distributed RAN 200. The Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

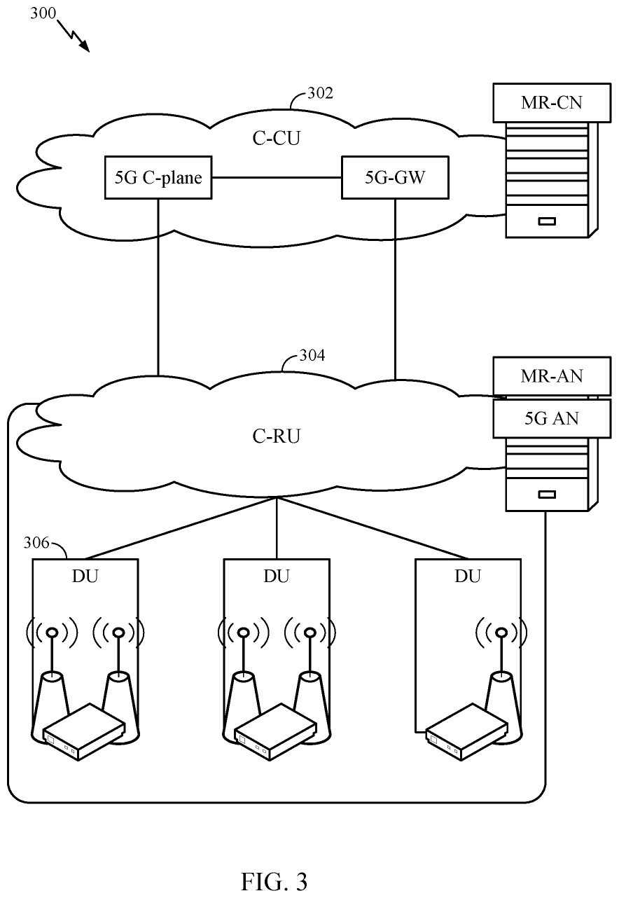

FIG. 3 illustrates an example physical architecture of a distributed RAN 300, according to aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

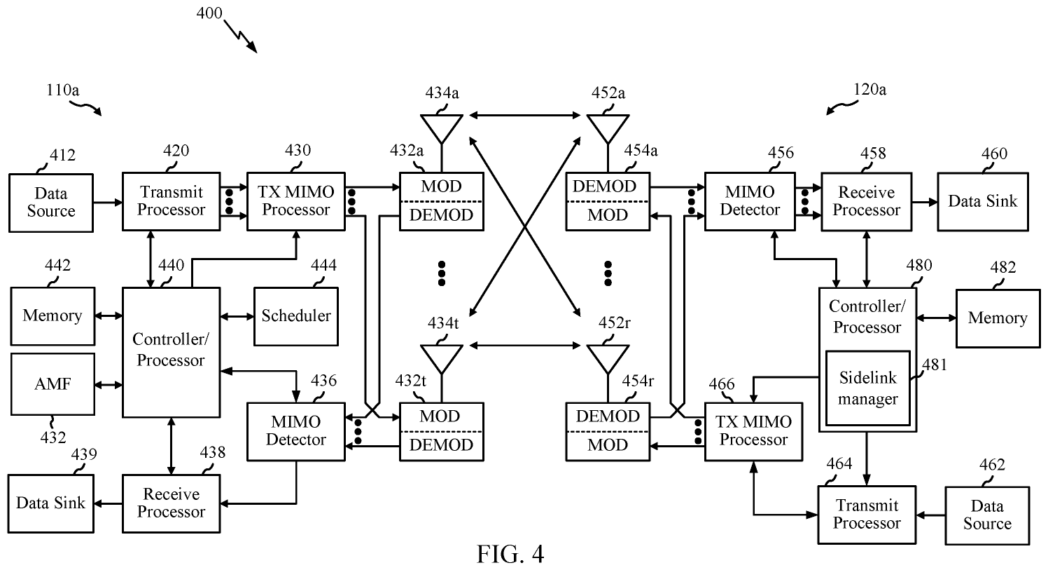

FIG. 4 illustrates example components of BS 110a and UE 120a (as depicted in FIG. 1), which may be used to implement aspects of the present disclosure. For example, antennas 452, processors 466, 458, 464, and/or controller/processor 480 of the UE 120a and/or UE 120b may be used to perform the various techniques and methods described herein with reference to FIGS. 14 and/or 15.

At the BS 110a, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120a, the antennas 452a through 452r may receive the downlink signals from the base station 110a and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120a to a data sink 460, and provide decoded control information to a controller/processor 480.

On the uplink, at UE 120a, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the base station 110a. At the BS 110a, the uplink signals from the UE 120a may be received by the antennas 434, processed by the modulators 432, detected by a MIMO detector 436 if applicable, and further processed by a receive processor 438 to obtain decoded data and control information sent by the UE 120a. The receive processor 438 may provide the decoded data to a data sink 439 and the decoded control information to the controller/processor 440.

The controllers/processors 440 and 480 may direct the operation at the BS 110a and the UE 120a, respectively. The processor 440 and/or other processors and modules at the BS 110a may perform or direct the execution of processes for the techniques described herein. As shown in FIG. 2, the controller/processor 480 of the UE 120a has a sidelink manager 481 that may be configured for transmitting a sidelink communication to another UE. Although shown at the controller/processor 480 and controller/processor 440, other components of the UE 120a and BS 110a may be used performing the operations described herein. The memories 442 and 482 may store data and program codes for BS 110a and UE 120a, respectively. A scheduler 444 may schedule UEs for data transmission on the downlink, sidelink, and/or uplink.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks (WLANs), which typically use an unlicensed spectrum).

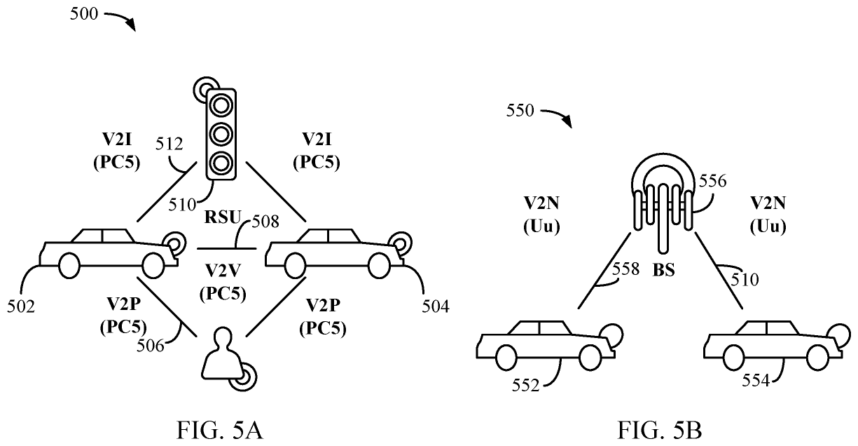

FIGS. 5A and 5B show diagrammatic representations of example vehicle to everything (V2X) systems in accordance with some aspects of the present disclosure. For example, the vehicles shown in FIGS. 5A and 5B may communicate via sidelink channels and may perform sidelink CSI reporting as described herein.

The V2X systems, provided in FIGS. 5A and 5B provide two complementary transmission modes. A first transmission mode, shown by way of example in FIG. 5A, involves direct communications (for example, also referred to as sidelink communications) between participants in proximity to one another in a local area. A second transmission mode, shown by way of example in FIG. 5B, involves network communications through a network, which may be implemented over a Uu interface (for example, a wireless communication interface between a RAN and a UE).

Referring to FIG. 5A, a V2X system 500 (for example, including vehicle-to-vehicle (V2V) communications) is illustrated with two vehicles 502, 504. The first transmission mode allows for direct communication between different participants in a given geographic location. As illustrated, a vehicle can have a wireless communication link 506 with an individual (i.e., vehicle to person (V2P), for example, via a UE) through a PC5 interface. Communications between the vehicles 502 and 504 may also occur through a PC5 interface 508. In a like manner, communication may occur from a vehicle 502 to other highway components (for example, roadside service unit 510), such as a traffic signal or sign (i.e., vehicle to infrastructure (V2I)) through a PC5 interface 512. With respect to each communication link illustrated in FIG. 5A, two-way communication may take place between elements, therefore each element may be a transmitter and a receiver of information. The V2X system 500 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 5B shows a V2X system 550 for communication between a vehicle 552 and a vehicle 554 through a network entity 556. These network communications may occur through discrete nodes, such as a base station (for example, an eNB or gNB), that sends and receives information to and from (for example, relays information between) vehicles 552, 554. The network communications through vehicle to network (V2N) links 558 and 510 may be used, for example, for long-range communications between vehicles, such as for communicating the presence of a car accident a distance ahead along a road or highway. Other types of communications may be sent by the node to vehicles, such as traffic flow conditions, road hazard warnings, environmental/weather reports, and service station availability, among other examples. Such data can be obtained from cloud-based sharing services.

In some circumstances, two or more subordinate entities (for example, UEs) may communicate with each other using sidelink signals. As described above, V2V and V2X communications are examples of communications that may be transmitted via a sidelink. When a UE is transmitting a sidelink communication on a sub-channel of a frequency band, the UE is typically unable to receive another communication (e.g., another sidelink communication from another UE) in the frequency band. Other applications of sidelink communications may include public safety or service announcement communications, communications for proximity services, communications for UE-to-network relaying, device-to-device (D2D) communications, Internet of Everything (IoE) communications, Internet of Things (IoT) communications, mission-critical mesh communications, among other suitable applications. Generally, a sidelink may refer to a direct link between one subordinate entity (for example, UE1) and another subordinate entity (for example, UE2). As such, a sidelink may be used to transmit and receive a communication (also referred to herein as a “sidelink signal”) without relaying the communication through a scheduling entity (for example, a BS), even though the scheduling entity may be utilized for scheduling or control purposes. In some examples, a sidelink signal may be communicated using a licensed spectrum (unlike wireless local area networks, which typically use an unlicensed spectrum).

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions.

For the operation regarding PSSCH, a UE performs either transmission or reception in a slot on a carrier. A reservation or allocation of transmission resources for a sidelink transmission is typically made on a sub-channel of a frequency band for a period of a slot. NR sidelink supports for a UE a case where all the symbols in a slot are available for sidelink, as well as another case where only a subset of consecutive symbols in a slot is available for sidelink.

PSFCH may carry feedback such as channel state information (CSI) related to a sidelink channel quality. A sequence-based PSFCH format with one symbol (not including AGC training period) may be supported. The following formats may be possible: a PSFCH format based on PUCCH format 2 and a PSFCH format spanning all available symbols for sidelink in a slot.

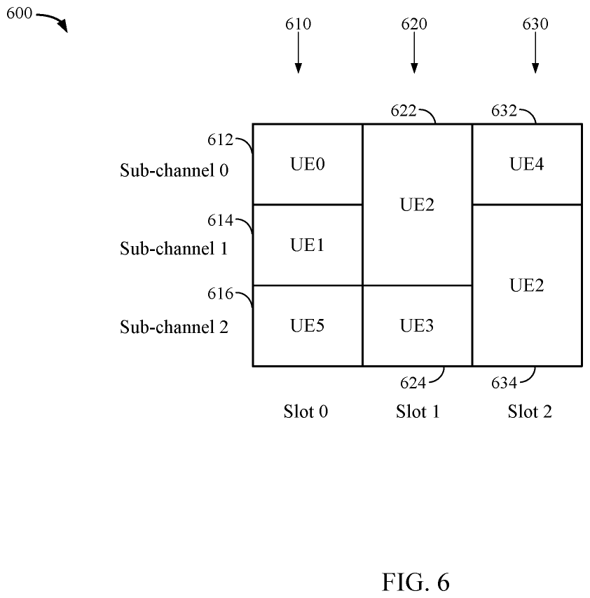

FIG. 6 is an example of how resources of a common resource pool 600 may be allocated for sidelink communications (broadcast and groupcast device-to-device or D2D) between UEs (e.g., UEs 110, shown in FIG. 1). As noted above, with reference to FIGS. 5A and 5B, sidelink generally refers to the link between two users, or user-relays can be used in different scenarios and for different applications. As previously described, when a UE is transmitting a sidelink communication on a sub-channel of a frequency band, the UE is typically unable to receive another communication (e.g., another sidelink communication from another UE) in the frequency band. Thus, sidelink communications may be referred to as being half-duplex. Thus, UEs 0, 1, and 5, which transmit sidelink communications 612, 614, and 616 respectively, cannot receive the sidelink communications from each other. That is, UE 0 cannot receive the sidelink transmissions 614 and 616. Similarly, UE 2 cannot receive the sidelink transmissions 624 and 632 from UEs 3 and 4, respectively. Also, UE 3 cannot receive sidelink transmission 622 from UE 2, and UE 4 cannot receive the sidelink transmission 634 from UE 2. In aspects of the present disclosure, a sidelink transmission(s) that cannot be received may be referred to as being “erased” for the UE or wireless node that cannot receive the sidelink transmission, because the UE has no information regarding that sidelink transmission. This is unlike other situations in which a UE fails to decode a transmission, because in those situations, the UE may retain some information regarding the transmission that the UE failed to decode, and the UE may combine that retained information with a retransmission that the UE receives to determine the transmission that the UE failed to decode.

According to previously known techniques, resource allocation is reservation based in NR sidelink communications. In these techniques, resource allocations are made in units of sub-channels in the frequency domain and are limited to one slot in the time domain. In the previously known techniques, a transmission may reserve resources in the current slot and in up to two future slots. Reservation information may be carried in sidelink control information (SCI). In the previously known techniques, sidelink control information (SCI) may be transmitted in two stages. A first stage SCI (SCI-1) may be transmitted on a physical sidelink control channel (PSCCH) and contains resource reservation information as well as information needed to decode a second stage SCI (SCI-2). A SCI-2 may be transmitted on the physical sidelink shared channel (PSSCH) and contains information needed to decode data on the shared channel (SCH) and to provide feedback (e.g., acknowledgments (ACKs) or negative acknowledgments (NAKs)) over the physical sidelink feedback channel (PSFCH).

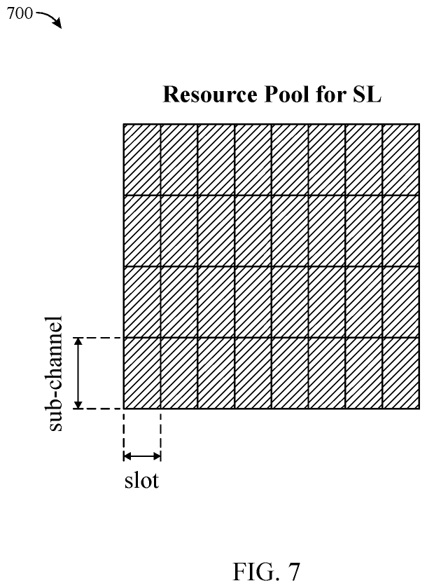

FIG. 7 is an example resource pool 700 for sidelink communication. As illustrated, the minimum resource allocation unit is a sub-channel in the frequency domain (i.e., as shown in they axis) and the resource allocation in the time domain is a slot (i.e., as shown in the x axis). For example, depending on subcarrier spacing (SCS) values, and depending on whether a normal cyclic prefix (CP) or an extended CP is used, a slot in the time domain may include 12 or 14 orthogonal frequency division multiplexing (OFDM) symbols.

In the frequency domain, each subchannel may include a set number of consecutive resource blocks (RBs), which may include 12 consecutive subcarriers with the same SCS, such as 10, 15, 20, 25 . . . etc. consecutive RBs depending on practical configuration. Hereinafter, each unit of resource in one slot and in one subchannel is referred to as a resource, or resource unit. For a certain resource pool, the resources therein may be referred to using the coordinates of the slot index (e.g., the n^{th} slot in the x axis of the time domain) and the subchannel index (e.g., the m^{th} subchannel in the y axis of the frequency domain). Interchangeably, the slot index may be referred to as the time index; and the subchannel index may be referred to as the frequency index.

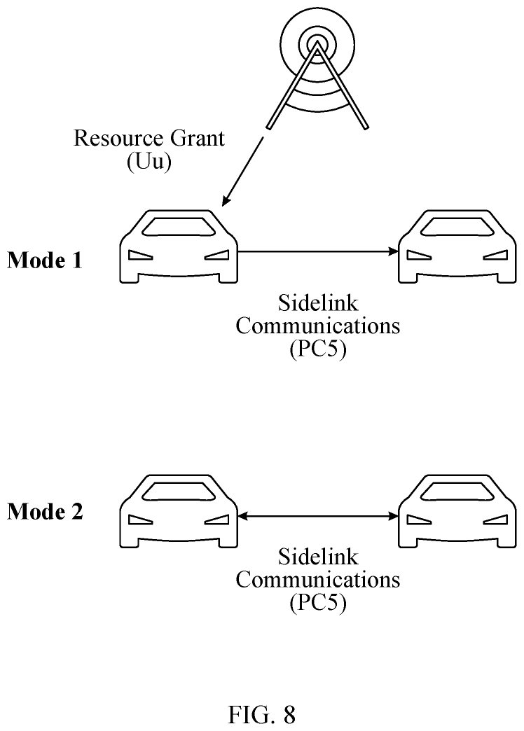

FIG. 8 illustrates two modes of resource allocation for sidelink communications, Mode 1 and Mode 2. Mode 1 and Mode 2 are briefly mentioned in FIGS. 5A and 5B, and are further discussed with respect to FIG. 8.

In Mode 1 sidelink communication, the sidelink resources are often scheduled by a gNB. In Mode 2 sidelink communication, the UE may autonomously select sidelink resources from a (pre)configured sidelink resource pool(s) based on the channel sensing mechanism. When the UE is in-coverage, a gNB may be configured to adopt Mode 1 or Mode 2. When the UE is out of coverage, only Mode 2 may be adopted.

In Mode 2, when traffic arrives at a transmitting UE, the transmitting UE may select resources for PSCCH and PSSCH, and/or reserve resources for retransmissions to minimize latency. Therefore, in conventional configurations the transmitting UE would select resources for PSSCH associated with PSCCH for initial transmission and blind retransmissions, which incurs unnecessary resources and the related power consumption. To avoid such resource waste and other similar resource duplication/blind reservation/redundancy, the UEs in sidelink communication may communicate to use a subset of the resources.

Example Reliability Enhancement for Sidelink Communication

Aspects of the present disclosure relate to wireless communications, and more particularly, to enhancements for device-to-device sidelink communication based on selectively forwarded future resource reservation information.

For example, a first sidelink receiving future resource reservation information (e.g., from a second UE for sidelink transmission to another UE) may only forward the resource reservation information if one or more conditions are met. By only forwarding the resource reservation information only when the one or more conditions are met, sidelink resources may be conserved and/or interference may be reduced.

In Mode-2 resource selection, side-link (SL) UEs autonomously reserve resources, as there is no central entity present (like a gNB). A sidelink transmitter UE (SL TX UE) may determine its transmission resources to use for sidelink transmission to another UE, from a set of candidate resources.

For example, to select a set of resources from the resource pool, a SL TX UE may monitor for future resource reservations by other SL UEs. For example, the SL TX UE may continuously decode SL control information (SCI) from one or more peers. This SCI may contain reservation information, e.g., resources (slots+RBs) peers will use in future.

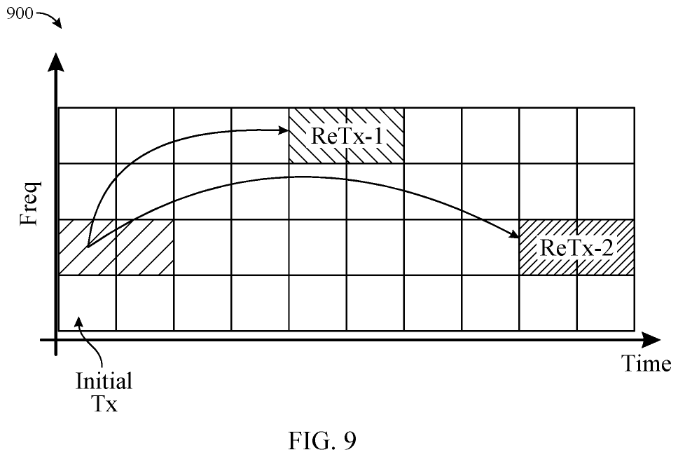

For example, as illustrated in FIG. 9, an SL TX UE may send SCI indicating resource reservations (from a candidate set with a resource pool) for an initial transmission, as well as future reservations for one or more retransmissions (e.g., ReTX-1 and ReTX-2).

When and if an SL TX UE acts on this information may depend on a few factors. For example, if the peer whose SCI is decoded has a high reference signal received power (RSRP), that peer is likely close to the UE and its transmissions would likely cause higher interference. Thus, the SL TX UE may remove all resources indicated in this SCI from the candidate set when selecting transmission resources.

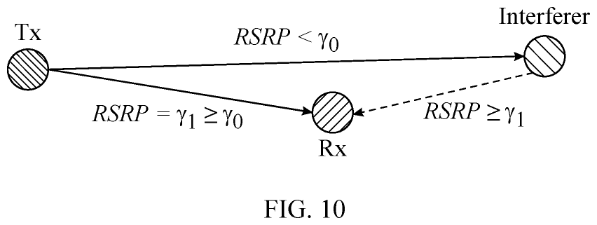

For example, referring to FIG. 10, a Tx UE may be sufficiently far away from a potential interferer, as indicated by an RSRP below a threshold value γ₀. On the other hand, both the TX UE and interferer may be sufficiently close to an Rx UE, as indicated by an RSRP γ₁ above the threshold value γ₀ for the Tx UE and an RSRP above γ₁ for the interferer.

Thus, in this example, the SL TX UE may remove all resources indicated in SCI from the Rx UE, from the candidate set when selecting transmission resources, but may not remove all resources indicated in SCI from the Rx UE.

From remaining resources in the candidate set (not removed), a SL TX UE may randomly select N resources for transmitting/retransmitting a TB. As indicated in FIG. 9, for every Tx, the SL TX UE may also reserve resources for up-to 2 retransmissions in the future.

There are various causes of loss in reliability for sidelink communications. For example, if an initial (e.g., 1^{st}) transmission is unprotected, that initial transmission may collide with another transmission. Loss in reliability may also be due to half-duplex operation, for example, where an intended receiver(s) also transmits at the same slot. Loss in reliability may also be due to collisions where two or more UEs may transmit on overlapping resources, for example when they are unable to decode control signaling from each other. Loss in reliability may also be due to link quality issues, for example, in cases of non-line-of-sight (NLoS), or a large distance between Tx and Rx UEs.

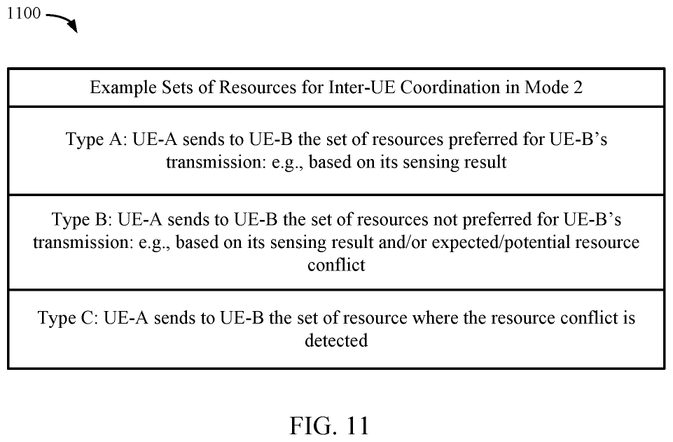

Various types of information may be shared as part of an effort to coordinate between UEs to try and enhance reliability of sidelink communications. For example, table 1100 of FIG. 11 lists different types of sets of resources that may be shared for inter-UE coordination, in accordance with certain aspects of the present disclosure.

For a first type, referred to as Type A, a first UE (UE-A) sends to a second UE (UE-B) the set of resources preferred for UE-B's transmission (e.g., based on its sensing result). For a second type, referred to as Type B, UE-A sends to UE-B the set of resources not preferred for UE-B's transmission: e.g., based on its sensing result and/or expected/potential resource conflict. For a third type, referred to as Type C, UE-A sends to UE-B the set of resources where the resource conflict is detected.

Different considerations may need to be made when performing such inter-UE coordination. For example, one consideration may be how/when UE-A determines the contents of “A set of resources”, including consideration of UL scheduling. Another consideration may be when UE-A sends “A set of resources” to UE-B, including which UE(s) it sends it to. Another consideration may be how UE-A and UE-B are determined (e.g., which UE(s) should forward information and which UE(s) should receive the information. Another consideration may be how UE-A sends “A set of resources” to UE-B, for example, including a signalling container used for carrying it, implicitly, explicitly, or both. Another consideration may be how/when/whether UE-B receives “A set of resources” and takes it into account in the resource selection for its own transmission (e.g., just because UE-B received information does not mean it needs to always consider it). Another consideration may be how/whether to define a relationship between support/signalling of inter-UE coordination and cast type.

In some cases, how/when information is forwarded may depend on the Type. For example, for conflict detection and indication (type C), a conflict may be detected between a first and a second UE by a third UE. In this case, an indication may be sent before the conflict event (pre-conflict) based on future reservation information. This may be applicable to both groupcast (e.g., broadcast/multi-cast) and unicast. The indication may be sent after the conflict event (post-conflict) based on decoding the current transmissions in conflict, which may be applicable mostly for groupcast communications.

For resource information forwarding (Type A/B), a first UE sends a second UE one or a set of resources to use or avoid. Continuing with the example shown in FIG. 11, the Rx UE may forward reservation information sent by the Interferer UE to its Tx UE. The Tx UE, upon receiving this information, can select an appropriate resource that does not create a conflict.

Blindly forwarding all resource information will either have high overhead or, for a fixed overhead, will lead to forwarded resource information that collide with one another. Forwarding reservations associated with a transmission which a UE wants to receive may help limit the amount of resource overhead and may work well for many groupcast cases where group size is large and uniform. This approach may not generalize to unicast or small group sizes, however.

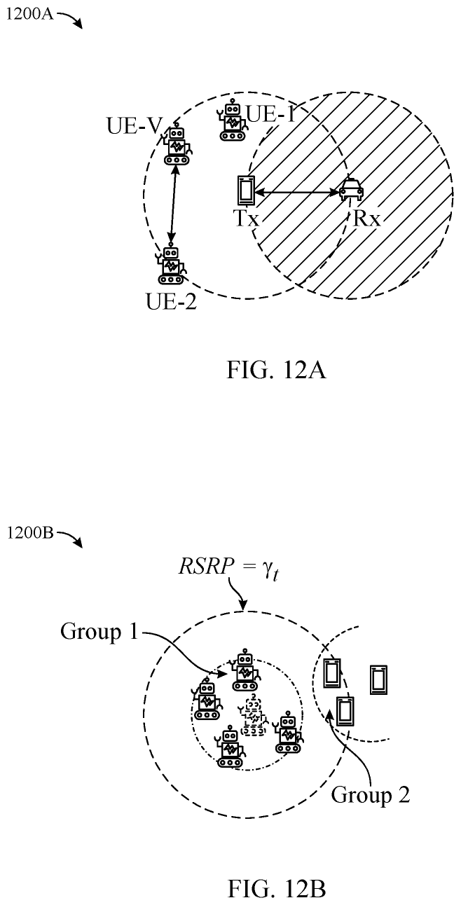

The techniques presented herein may be utilized in unicast or groupcast scenarios. For example, FIG. 12A, an example of unicast transmissions sent from a Tx UE to a single Rx UE. For unicast communications, a UE is only interested in receiving from, or transmitting to, one or few other UEs. In this case, only one second UE forwarding the reservation information from a first UE may offer little or no gains to reliability.

For example, referring to FIG. 12A, at UE-V a reservation sent by the Tx UE may not be received (e.g., due to collision/half duplex etc.). If only the Rx UE forwards the reservation information, the information may not reach UE-V and may actually create collisions for the transmission between UE-2 and UE-V. According to certain aspects presented herein, however, UE-1, although not involved in either of the unicast sessions, may help enhance reliability by forwarding future resource reservation information.

FIG. 12B illustrates an example of groupcast transmissions sent from a Tx UE to a group of UEs (e.g., Group 1 or Group 2). The illustrated example shows relatively small group sizes. In this example, some UEs in Group 1 and Group 2 may be in each other's communication range but not in the group (for example, if a group is determined by a feedback distance threshold). In this case, reservation information sent from members in Group 1 is not forwarded to members in Group 2, even though transmissions in one group may lead to collisions with transmission in the other group.

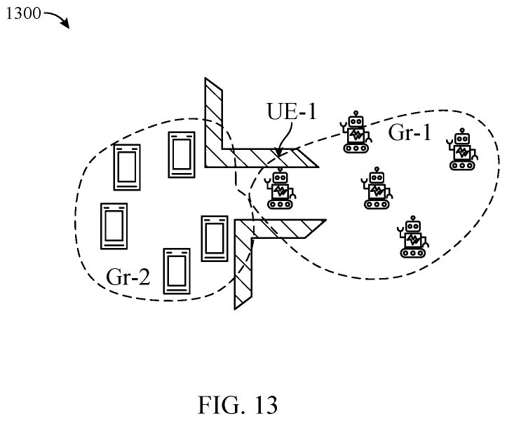

FIG. 13 illustrates another example, with non-uniform group geometry, in which aspects of the present disclosure may help enhance reliability of sidelink communications. In the illustrated example, UE-1 is in Group 1 but is also close to Group 2 UEs (though other Group 1 members are far away). In this scenario, if UE-1 does not forward reservation information from Group-2 to Group-1, other Group 1 UEs, who cannot hear from Group 2 UEs may transmit on colliding resources, which will likely lead to high packet losses at UE-1.

Based on these considerations, aspects of the present disclosure provide mechanisms for efficient resource information forwarding for SL transmissions. For example, by selectively forwarding future resource reservation information, unnecessary transmissions may be avoided, conserving resources and reducing interference.

FIG. 14 illustrates example operations 1400 for wireless communications by a first UE, in accordance with certain aspects of the present disclosure. For example, operations 1400 may be performed by a UE 120a of FIG. 1 or FIG. 4 when performing sidelink communications with another UE.

Operations 1400 begin, at 1402, by receiving resource reservation information indicating a reservation of a future resource by at least a second UE. At 1404, the first UE forwards the resource reservation information to one or more other UEs when at least one condition is met.

FIG. 15 illustrates example operations 1500 for wireless communications by a first UE, in accordance with certain aspects of the present disclosure. For example, operations 1500 may be performed by a UE 120b of FIG. 1 to process future resource reservation information received from another UE (e.g., a UE performing the operations 1400 of FIG. 14).

Operations 1500 begin, at 1502, by receiving, from a second UE, resource reservation information indicating a reservation of a future resource by at least a third UE. At 1504, the first UE takes one or more actions based on the resource reservation information

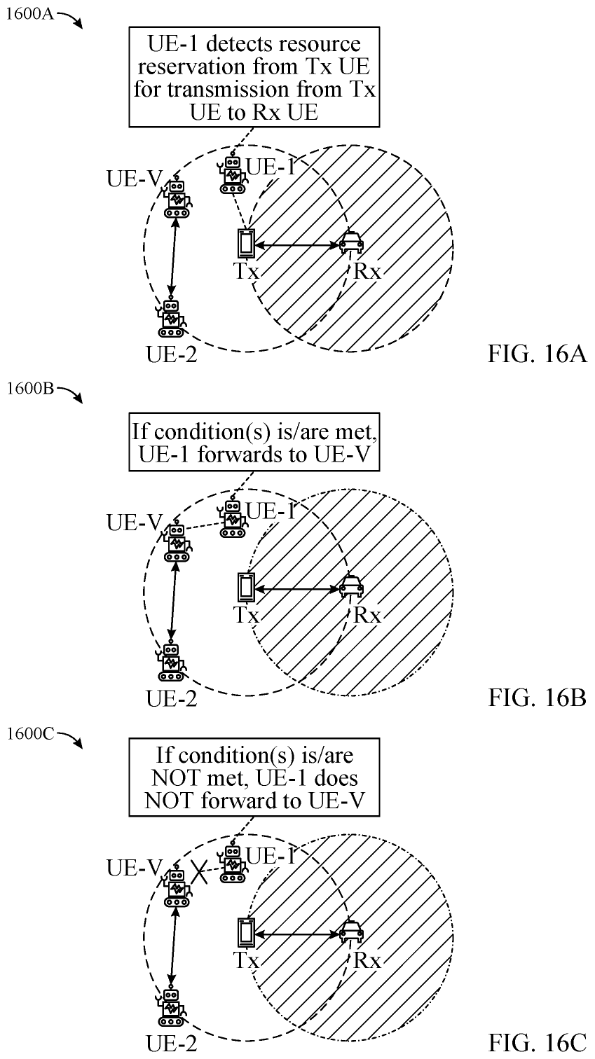

Operations 1400 and 1500 may be understood with reference to FIGS. 16A-16C, which illustrate selective future resource reservation forwarding applied to the unicast scenario described above with reference to FIG. 12A, in accordance with certain aspects of the present disclosure. For the illustrated example, it may be assumed that UE-1 performs operations 1400 of FIG. 14, while UE-V performs operations 1500 of FIG. 15.

As illustrated, in FIG. 16A, UE-1 may detect future resource reservation information from Tx UE (e.g., via a decoded SCI) for transmission from Tx UE to Rx UE. As illustrated in FIG. 16B, if one or more conditions are met, UE-1 forwards the future resource reservation information to UE-V. If the one or more conditions are not met, as illustrated in FIG. 16C, UE-1 forwards the future resource reservation information to UE-V.

There are various options for a UE receiving a reservation for a future resource. In one case, the receiving UE may determine that the resource being reserved is for a transmission for which it is the intended receiver. In this case, the UE may forward the reservation information (to one or more other UEs) in a next available forwarding occasion/resource and/or may forward the information via PSSCH transmissions.

In one case, a receiving UE may choose to transmit future resource reservation information with other forwarding information, which may include self-reservation information, distance information, a number of hops, or RSRP for the SCI (that included the information) as measured at the receiving UE.

In another case, it may transmit the future resource reservation information by itself. The future resource reservation information may be transmitted by itself, for example, when the information is time critical and should be shared quickly to be of benefit (e.g., if the resource reservation is in the very near future).

In some cases, a receiving UE may determine that it is not the intended receiver for a transmission on the reserved future resource. In this case, the receiver UE may still determine to forward the resource reservation information if one or more conditions apply. For example, the receiving UE (that is not an intended receiver) may still forward the information if: 1) the received signal reference power (RSRP) of the transmission containing the reservation information is greater than a threshold (RSRP>P₀), 2) the received signal reference quality (RSRQ) falls in a range (e.g., Q₀<RSRQ<Q₁) indicating a possible collision over the reserved resources reserve info (where Q₀ may be 0, and Q₁ may be infinity), 3) the received signal to interference ratio falls in a range (e.g., G₀<SINR<G₁) (where G₀ may be 0, and G₁ may be infinity), 4) the hop-count for the reservation information is below a maximum count value (e.g., Hop-count<C₀) preventing over reservation or forwarding, and/or 5) the distance between the UE transmitting the reserve transmitting the reservation information and the UE forwarding this information falls in a range (e.g., falls in a range (e.g., d₀<Dist<d₁) [where d₀>=0, d₁<=infinity]. In other words, the UE may use one or a combination of the above conditions to determine whether to forward future resource reservation information.

A UE receiving forwarded future resource reservation information may take various actions. For example, the UE receiving forwarded future resource reservation information may take this information into considering when selecting its own Tx resources.

In one case, the UE receiving the forwarded future resource reservation information may apply a level of protection to the candidate resources based on various considerations. Such considerations may include, for example, an intention of the UE to receive a packet or transmit on the reserved resources, RSRP of the forwarding message (as detected at the UE receiving the forwarded information), an RSRP level (or RSRP protection level) indicated in the forwarding message, or a priority of the reservation.

In some cases, the UE receiving the forwarded future resource reservation information may use an estimated signal-to-interference ratio (SINR) when a resource is not reserved for an intended transmission or location information of the UE reserving this resource if available in the forwarded message. In some cases, location information (e.g., based on/indicated by a zone ID). A UE receiving the forwarded future resource reservation information may use any combination of the above considerations to apply a level of protection to a candidate resource. In still another case, the UE behavior may be up to UE implementation.

Example Communications Devices

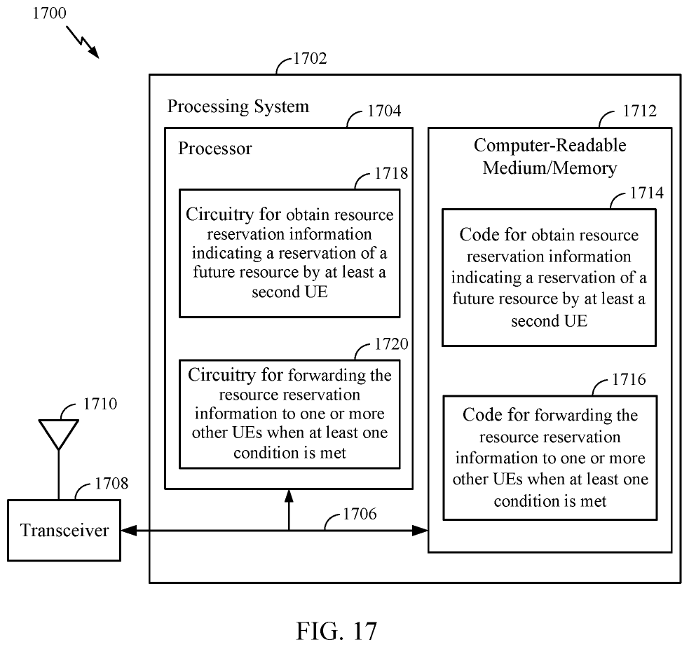

FIG. 17 illustrates a communications device 1700 that may include various components (e.g., corresponding to means-plus-function components) configured to perform operations for the techniques disclosed herein, such as the operations 1000 illustrated in FIG. 14. The communications device 1700 includes a processing system 1702 coupled to a transceiver 1708. The transceiver 1708 is configured to transmit and receive signals for the communications device 1700 via an antenna 1710, such as the various signals as described herein. The processing system 1702 may be configured to perform processing functions for the communications device 1700, including processing signals received and/or to be transmitted by the communications device 1700.

The processing system 1702 includes a processor 1704 coupled to a computer-readable medium/memory 1712 via a bus 1706. In certain aspects, the computer-readable medium/memory 1712 is configured to store instructions (e.g., computer-executable code) that when executed by the processor 1704, cause the processor 1704 to perform the operations 1000 illustrated in FIG. 14, or other operations for recovering a sidelink communication that is missed by a wireless node due to the wireless node transmitting while the sidelink communication is occurring. In certain aspects, computer-readable medium/memory 1712 stores code 1714 for obtain resource reservation information indicating a reservation of a future resource by at least a second UE; and code 1716 for forwarding the resource reservation information to one or more other UEs when at least one condition is met. In certain aspects, the processor 1704 has circuitry configured to implement the code stored in the computer-readable medium/memory 1712. The processor 1704 includes circuitry 1718 for obtain resource reservation information indicating a reservation of a future resource by at least a second UE; and circuitry for 1720 for forwarding the resource reservation information to one or more other UEs when at least one condition is met.

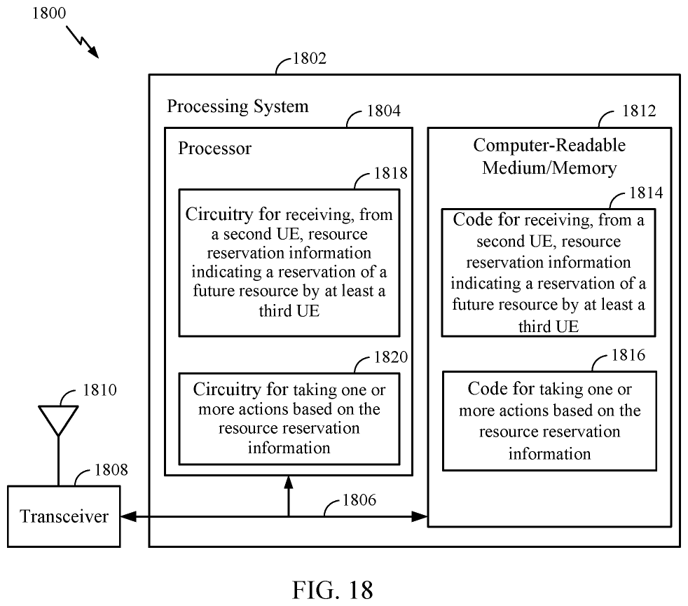

FIG. 18 illustrates a communications device 1800 that may include various components (e.g., corresponding to means-plus-function components) configured to perform operations for the techniques disclosed herein, such as the operations 1000 illustrated in FIG. 15. The communications device 1800 includes a processing system 1802 coupled to a transceiver 1808. The transceiver 1808 is configured to transmit and receive signals for the communications device 1800 via an antenna 1810, such as the various signals as described herein. The processing system 1802 may be configured to perform processing functions for the communications device 1800, including processing signals received and/or to be transmitted by the communications device 1800.

The processing system 1802 includes a processor 1804 coupled to a computer-readable medium/memory 1812 via a bus 1806. In certain aspects, the computer-readable medium/memory 1812 is configured to store instructions (e.g., computer-executable code) that when executed by the processor 1804, cause the processor 1804 to perform the operations 1000 illustrated in FIG. 15, or other operations for recovering a sidelink communication that is missed by a wireless node due to the wireless node transmitting while the sidelink communication is occurring. In certain aspects, computer-readable medium/memory 1812 stores code 1814 for obtaining, from a second UE, resource reservation information indicating a reservation of a future resource by at least a third UE; and code 1816 for taking one or more actions based on the resource reservation information. In certain aspects, the processor 1804 has circuitry configured to implement the code stored in the computer-readable medium/memory 1812. The processor 1804 includes circuitry 1818 for obtaining, from a second UE, resource reservation information indicating a reservation of a future resource by at least a third UE; and circuitry 1820 for taking one or more actions based on the resource reservation information.

### Example Aspects

Aspect 1: A method for wireless communications by a first user equipment (UE), comprising: receiving resource reservation information indicating a reservation of a future resource by at least a second UE; and forwarding the resource reservation information to one or more other UEs when at least one condition is met.

Aspect 2: The method of Aspect 1, wherein the first UE forwards the resource reservation information in at least one of: a subsequent available forwarding occasion, a subsequent available sidelink resource, or a physical sidelink shared channel (PSSCH) transmission.

Aspect 3: The method of any one of Aspects 1-2, wherein the at least one condition comprises a condition that the first UE is an intended recipient of a transmission for which the future resource is reserved.

Aspect 4: The method of any one of Aspects 1-3, wherein the first UE also forwards additional information with the resource reservation information.

Aspect 5: The method of Aspect 4, wherein the additional information comprises resource reservation information indicating a reservation of a future resource by at least one of the first UE or a third UE.

Aspect 6: The method of Aspect 4, wherein whether or not the UE forwards additional information with the resource reservation information depends on timing of the future resource.

Aspect 7: The method of any one of Aspects 1-6, wherein the at least one condition comprises a condition that involves a received signal quality metric, observed at the first UE, of a transmission containing the resource reservation information.

Aspect 8: The method of Aspect 7, wherein: the received signal quality metric comprises reference signal received power (RSRP); and the at least one condition comprises a condition that the RSRP is greater than a threshold value.

Aspect 9: The method of Aspect 7, wherein: the received signal quality metric comprises reference signal received quality (RSRQ); and the at least one condition comprises a condition that the RSRQ is within a range.

Aspect 10: The method of Aspect 7, wherein: the received signal quality metric comprises signal to interference and noise ratio (SINR); and the at least one condition comprises a condition that the SINR is within a range.

Aspect 11: The method of any one of Aspects 1-10, wherein the at least one condition comprises a condition that a hop count for the reservation information, that indicates a number of UEs that have forwarded the reservation information before reception by the first UE, is below a threshold value.

Aspect 12: The method of any one of Aspects 1-11, wherein the at least one condition comprises a condition that a distance between the first UE and the second UE is within a range.

Aspect 13: The method in any one of Aspects 1-12, where the at least one condition and an associated range or threshold are at least one of: part of UE pre-configuration or configured by a network entity.

Aspect 14: A method for wireless communications by a first user equipment (UE), comprising: receiving, from a second UE, resource reservation information indicating a reservation of a future resource by at least a third UE; and taking one or more actions based on the resource reservation information.

Aspect 15: The method of Aspect 14, wherein the one or more actions comprise at least one of: avoiding transmitting on the future resource or taking into account the resource reservation information when determining future transmission resources.

Aspect 16: The method of any one of Aspects 14-15, wherein the one or more actions depend on whether the first UE intends to receive a transmission for which the future resource reservation is being made.

Aspect 17: The method of any one of Aspects 14-16, wherein the one or more actions depend on a received signal quality metric, observed at the first UE, of a transmission containing the resource reservation information.

Aspect 18: The method of any one of Aspects 14-17, wherein the one or more actions depend on a received signal quality metric, observed at the second UE, of a transmission containing the resource reservation information received by the second UE.

Aspect 19: The method of any one of Aspects 14-18, wherein the one or more actions depend on a priority of the reservation for the future resource.

Aspect 20: The method of any one of Aspects 14-19, wherein the one or more actions depend on an estimated signal-to-interference ratio (SINK) if a resource overlapping with the future resource is used for a transmission.

Aspect 21: The method of any one of Aspects 14-20, wherein the one or more actions depend on location information of the third UE.

Aspect 23: A first user equipment, comprising means for performing the operations of one or more of Aspects 1-13.

Aspect 24: A first user equipment, comprising a transceiver and a processing system including at least one processor configured to perform the operations of one or more of Aspects 1-13.

Aspect 25: An apparatus for wireless communication by a first user equipment (UE), comprising: a memory; and at least one processor coupled to the memory, the at least one processor configured to obtain resource reservation information indicating a reservation of a future resource by at least a second UE, and forward the resource reservation information to one or more other UEs when at least one condition is met.

Aspect 26: A computer-readable medium for wireless communications, comprising codes executable to: obtain resource reservation information indicating a reservation of a future resource by at least a second UE; and forward the resource reservation information to one or more other UEs when at least one condition is met.

Aspect 27: A first user equipment, comprising means for performing the operations of one or more of Aspects 14-21.

Aspect 28: A first user equipment, comprising a transceiver and a processing system including at least one processor configured to perform the operations of one or more of Aspects 14-21.

Aspect 29: An apparatus for wireless communication by a first user equipment (UE), comprising: a memory; and at least one processor coupled to the memory, the at least one processor configured to obtain, from a second UE, resource reservation information indicating a reservation of a future resource by at least a third UE; and take one or more actions based on the resource reservation information.

Aspect 30: A computer-readable medium for wireless communications, comprising codes executable by an apparatus to: obtain, from a second UE, resource reservation information indicating a reservation of a future resource by at least a third UE; and take one or more actions based on the resource reservation information.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components. For example, various operations shown in FIGS. 14 and 15 may be performed by various processors shown in FIG. 4, such as processors 466, 458, 464, and/or controller/processor 480 of the UE 120a (and/or UE 120b of FIG. 1).

Means for receiving may include a transceiver, a receiver or at least one antenna and at least one receive processor illustrated in FIG. 2. Means for transmitting, means for sending or means for outputting may include, a transceiver, a transmitter or at least one antenna and at least one transmit processor illustrated in FIG. 2. Means for forwarding, means for taking one or more actions, means for avoiding transmitting, and means for performing may include a processing system, which may include one or more processors, such as processors 458, 464 and 466, and/or controller/processor 480 of the UE 120a and/or processors 420, 430, 438, and/or controller/processor 440 of the BS 110a shown in FIG. 4.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations 1000 described herein and illustrated in FIGS. 14 and 15.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a first user equipment (UE), comprising:
receiving resource reservation information indicating a reservation of a future resource by at least a second UE; and
forwarding the resource reservation information to one or more other UEs when at least one condition is met.

2. The method of claim 1, wherein the first UE forwards the resource reservation information in at least one of: a subsequent available forwarding occasion, a subsequent available sidelink resource, or a physical sidelink shared channel (PSSCH) transmission.

3. The method of claim 1, wherein the at least one condition comprises a condition that the first UE is an intended recipient of a transmission for which the future resource is reserved.

4. The method of claim 1, wherein the first UE also forwards additional information with the resource reservation information.

5. The method of claim 4, wherein the additional information comprises resource reservation information indicating a reservation of a future resource by at least one of the first UE or a third UE.

6. The method of claim 4, wherein whether or not the UE forwards additional information with the resource reservation information depends on timing of the future resource.

7. The method of claim 1, wherein the at least one condition comprises a condition that involves a received signal quality metric, observed at the first UE, of a transmission containing the resource reservation information.

8. The method of claim 7, wherein:
the received signal quality metric comprises reference signal received power (RSRP); and
the at least one condition comprises a condition that the RSRP is greater than a threshold value.

9. The method of claim 7, wherein:
the received signal quality metric comprises reference signal received quality (RSRQ); and
the at least one condition comprises a condition that the RSRQ is within a range.

10. The method of claim 7, wherein:
the received signal quality metric comprises signal to interference and noise ratio (SINR); and
the at least one condition comprises a condition that the SINR is within a range.

11. The method of claim 1, wherein the at least one condition comprises a condition that a hop count for the resource reservation information, that indicates a number of UEs that have forwarded the resource reservation information before reception by the first UE, is below a threshold value.

12. The method of claim 1, wherein the at least one condition comprises a condition that a distance between the first UE and the second UE is within a range.

13. The method in claim 12, where the at least one condition and the associated range or threshold are at least one of: part of UE pre-configuration or configured by a network entity.

14. A first user equipment configured for wireless communications, comprising: a memory comprising computer-executable instructions; and a processor configured to execute the computer-executable instructions and cause the first user equipment to:
obtain resource reservation information indicating a reservation of a future resource by at least a second UE; and
forward the resource reservation information to one or more other UEs when at least one condition is met.

15. A method for wireless communications by a first user equipment (UE), comprising:
receiving, from a second UE, resource reservation information indicating a reservation of a future resource by at least a third UE; and
taking one or more actions based on the resource reservation information.

16. The method of claim 15, wherein the one or more actions comprise at least one of: avoiding transmitting on the future resource or taking into account the resource reservation information when determining future transmission resources.

17. The method of claim 15, wherein the one or more actions depend on whether the first UE intends to receive the transmission for which the reservation of the future resource is being made.

18. The method of claim 15, wherein the one or more actions depend on a received signal quality metric, observed at the first UE, of a transmission containing the resource reservation information.

19. The method of claim 15, wherein the one or more actions depend on a received signal quality metric, observed at the second UE, of a transmission containing the resource reservation information received by the second UE.

20. The method of claim 15, wherein the one or more actions depend on a priority of the reservation for the future resource.

21. The method of claim 15, wherein the one or more actions depend on an estimated signal-to-interference ratio (SINK) if a resource overlapping with the future resource is used for a transmission.

22. The method of claim 15, wherein the one or more actions depend on location information of the third UE.

23. A first user equipment configured for wireless communications, comprising: a memory comprising computer-executable instructions; and a processor configured to execute the computer-executable instructions and cause the first user equipment to:
obtain, from a second UE, resource reservation information indicating a reservation of a future resource by at least a third UE; and
take one or more actions based on the resource reservation information.
